(19) United States
(12) Patent Application Publication
(10) Pub. No.: US 2018/0260281 A1
(43) Pub. Date: Sep. 13, 2018

(54) RESTORING A STORAGE VOLUME FROM A BACKUP

(71) Applicant: Hewlett Packard Enterprise Development LP, Houston, TX (US)

(72) Inventor: Russell Ian Monk, Caldicot (GB)

(21) Appl. No.: 15/453,042

(22) Filed: Mar. 8, 2017

(51) Int. Cl. G06F 11/14; G06F 3/06

(52) U.S. Cl. CPC G06F 11/1448; G06F 3/065; G06F 2201/84; G06F 3/067; G06F 3/0665; G06F 3/0619

(57) ABSTRACT

Examples disclosed herein relate to restoration of a storage volume. In an example, a backup of a snapshot of a storage volume may be stored on a backup device. An allocation map for the snapshot may be stored in a data store on the backup device. The respective backups of additional snapshots of the storage volume may be stored on the backup device. For each additional snapshot, a difference map may be stored in the data store. In response to a request to restore the backup of the snapshot, a latest snapshot of the storage volume may be generated. A combined map may be generated based on the difference map for the latest snapshot and respective difference maps of the additional snapshots backed up on the backup device prior to the latest snapshot. The blocks that changed between the snapshot and the latest snapshot may be copied to storage device.

### BACKGROUND

Organizations may need to deal with a vast amount of business data these days, which could range from a few terabytes to multiple petabytes of data. Loss of data or inability to access data may impact an enterprise in various ways such as loss of potential business and lower customer satisfaction.

### BRIEF DESCRIPTION OF THE DRAWINGS

For a better understanding of the solution, embodiments will now be described, purely by way of example, with reference to the accompanying drawings, in which:

FIG. 1 is a diagram of an example computing environment for restoring a storage volume from a backup;

FIG. 2 illustrates an example time series representing snapshots of a storage volume at different time periods;

FIG. 3 is a block diagram of an example data store representing relationships between snapshots of a storage volume via an allocation map and difference maps;

FIG. 4 is a block diagram of an example system for restoring a storage volume from a backup;

FIG. 5A is a block diagram of an example method of restoring a storage volume from a backup;

FIG. 5B is a continuation of the example method of FIG. 5A; and

FIG. 6 is a block diagram of an example system including instructions in a machine-readable storage medium for restoring a storage volume from a backup.

### DETAILED DESCRIPTION

Organizations may back up their data for various reasons. For example, in order to recover data after its loss, or to recover data from an earlier time. Organizations may back up their data to a backup storage system or device. A backup storage system may include, for example, a secondary storage media such as external hard disk drives, solid-state drives (SSD), a storage array, USB flash drives, storage tapes, CDs, and DVDs.

In an example, an approach to data backup may include taking snapshots of a storage volume on a storage device, and then backing up the snapshots to a backup device. During a restore operation, the data stored in a backup may be copied from the backup device to the storage device. However, restoring a large storage volume in this manner by copying all data from the backup device to the storage device, especially over a network, may take a lot of time. Further, the process may use valuable network bandwidth and may duplicate data on the storage device as blocks holding the same data may be copied. Needless to say, neither of these aspects related to restoration of a storage volume is desirable from an organization's perspective.

To address these issues, the present disclosure describes various examples for restoring a storage volume from a backup. In an example, a backup of a snapshot of a storage volume on a storage device may be generated. The backup of the snapshot may be stored on a backup device. An allocation map for the snapshot may be generated. The allocation map may identify written blocks on the snapshot. The allocation map for the snapshot may be stored in a data store on the backup device. The respective backups of additional snapshots of the storage volume may be generated. The respective backups of additional snapshots may be stored on the backup device. For each additional snapshot that is backed up on the backup device, a difference map may be generated. The difference map for an additional snapshot may identify changed blocks on the additional snapshot relative to a previous snapshot last backed up on the backup device. Each difference map may be stored in the data store on the backup device. In response to a request to restore the backup of the snapshot, a latest snapshot of the storage volume may be generated. A difference map for the latest snapshot may be generated. The difference map for the latest snapshot may identify changed blocks on the latest snapshot relative to a last snapshot backed up on the backup device. A combined map may be generated based on the difference map for the latest snapshot and respective difference maps of the additional snapshots backed up on the backup device prior to the latest snapshot. The blocks that changed between the snapshot and the latest snapshot from the combined map may be identified. The changed blocks may be copied from the backup device to the storage device.

Thus, examples described herein provide an efficient mechanism of restoring a storage volume. For example, examples described herein may reduce the data transferred from a backup device during a restore operation, allow block reuse thereby speeding up the restore process, improve storage efficiency, and/or free up network bandwidth.

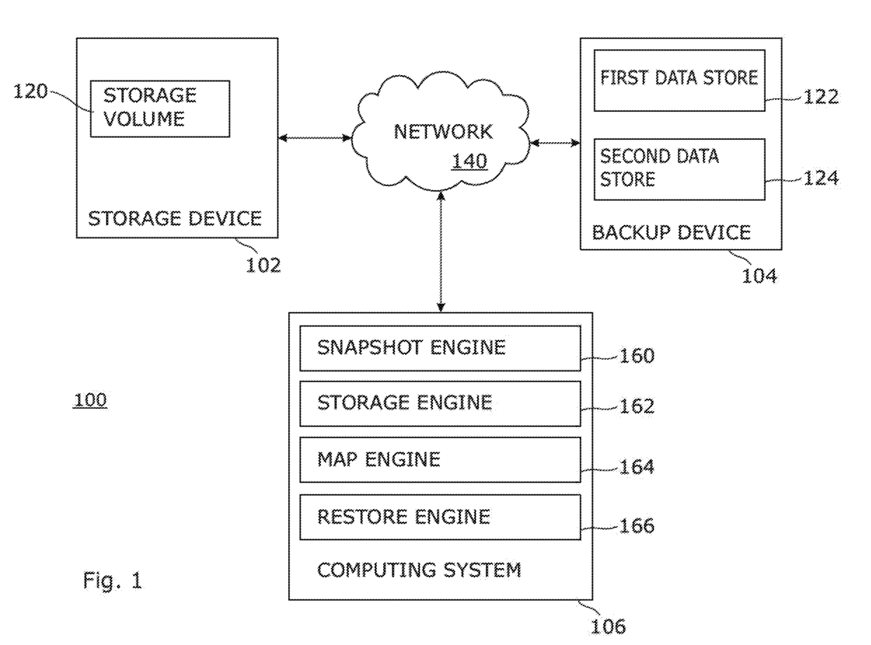

FIG. 1 is a block diagram of an example computing environment 100 for restoring a storage volume from a backup. Computing environment 100 may include a storage device 102, a backup device 104, and a computing system 106. Although only storage device, one backup device, and one computing system are shown in FIG. 1, other examples of this disclosure may include more than one storage device, more than one backup device, and more than one computing system.

In some examples, storage device 102 and backup device 104 may each be an internal storage device, an external storage device, or a network attached storage device. Some non-limiting examples of storage device 102 and backup device 104 may each include a hard disk drive, a storage disc (for example, a CD-ROM, a DVD, etc.), a storage tape, a solid state drive, a USB drive, a Serial Advanced Technology Attachment (SATA) disk drive, a Fibre Channel (FC) disk drive, a Serial Attached SCSI (SAS) disk drive, a magnetic tape drive, an optical jukebox, and the like. In an example, storage device 102 and backup device 104 may each be a Direct Attached Storage (DAS) device, a Network Attached Storage (NAS) device, a Redundant Array of Inexpensive Disks (RAID), a data archival storage system, or a block-based device over a storage area network (SAN). In some examples, storage device 102 and backup device 104 may each be a storage array, which may include one or more storage drives (for example, hard disk drives, solid state drives, etc.).

Computing system 106 may be any type of computing device capable of executing machine-readable instructions. Examples of computing system 106 may include, without limitation, a server, a desktop computer, a notebook computer, a tablet computer, a thin client, a mobile device, a personal digital assistant (PDA), and the like. In an example, computer system may include a virtual machine (VM). In an example, the virtual machine may be present in a cloud system. In another example, the virtual machine may be present on storage device 102 or backup device 104.

In an example, the physical storage space provided by storage device 102 may be presented as a logical storage space. Such logical storage space (also referred as “logical volume”, “virtual disk”, or “storage volume”) may be identified using a “Logical Unit Number” (LUN). In another instance, physical storage space provided by storage device may be presented as multiple logical volumes. In such case, each of the logical storage spaces may be referred to by a separate LUN. Thus, if storage device 102 is a physical disk, a LUN may refer to the entire physical disk, or a subset of the physical disk or disk volume. In another example, if storage device 102 is a storage array comprising multiple storage disk drives, physical storage space provided by the disk drives may be aggregated as a logical storage space. The aggregated logical storage space may be divided into multiple logical storage volumes, wherein each logical storage volume may be referred to by a separate LUN. LUNs, thus, may be used to identify individual or collections of physical disk devices for address by a protocol associated with a Small Computer System Interface (SCSI), Internet Small Computer System Interface (iSCSI), or Fibre Channel (FC).

Computing system 106 may be in communication with storage device 102 and backup device 104, for example, via a computer network 140. Computer network 140 may be a wireless or wired network. Computer network 140 may include, for example, a Local Area Network (LAN), a Wireless Local Area Network (WAN), a Metropolitan Area Network (MAN), a Storage Area Network (SAN), a Campus Area Network (CAN), or the like. Further, computer network 140 may be a public network (for example, the Internet) or a private network (for example, an intranet).

Storage device 102 may be in communication with backup device 104, for example, via a computer network (not illustrated). Such a network may be similar to the network described above. Storage device may communicate with backup device 104 via a suitable interface or protocol such as, but not limited to, Internet Small Computer System Interface (iSCSI), Fibre Channel, Fibre Connection (FICON), HyperSCSI, and ATA over Ethernet.

In an example, computing system 106 may include a snapshot engine 160, a storage engine 162, a map engine 164, and a restore engine 166.

Engines 160, 162, 164, and 166 may include any combination of hardware and programming to implement the functionalities of the engines described herein. In examples described herein, such combinations of hardware and software may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one engine of computing system 106. In some examples, the at least one machine-readable storage medium may store instructions that, when executed by the at least one processing resource, at least partially implement some or all engines of computing system 106. In such examples, computing system 106 may include the at least one machine-readable storage medium storing the instructions and the at least one processing resource to execute the instructions.

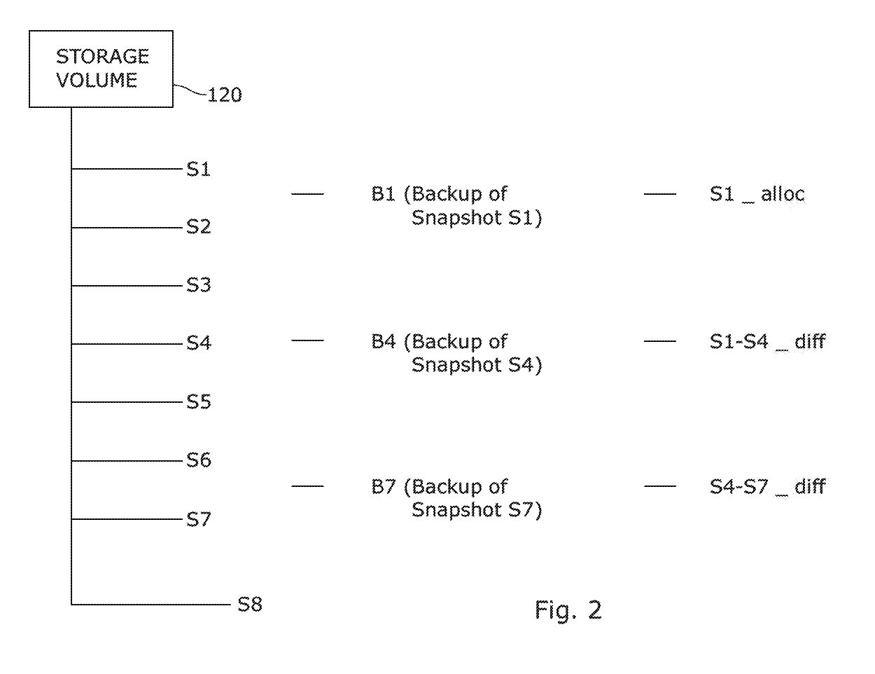

Snapshot engine 160 may be used to generate a snapshot(s) of a storage volume(s) on storage device 102. As use herein, a “snapshot” may refer to a point-in-time record of data on a storage device. Snapshot engine 160 may generate snapshots of a storage volume at different time periods. FIG. 2 illustrates snapshots (for example, S1, S2, S3, S4, S5, S6, S7, and S8) of a storage volume generated at different time periods.

In an example, snapshot engine 160 may generate a backup of a snapshot of a storage volume (for example, 120). In the event additional snapshots of storage volume 120 are generated, snapshot engine 160 may generate respective backups of some or all of the additional snapshots. As used herein, an “additional snapshot” may refer to any snapshot beyond the first snapshot. As used herein, the “first snapshot” refers to a snapshot at a reference point in time, not necessarily the first snapshot. As used herein, a “backup” may include a copy of data in a snapshot.

In an example, storage engine 162 may store the backup (for example, 131) of the first snapshot (for example, S1) of storage volume 120 to backup device 104. In an example, storage engine 162 may store the backup of the first snapshot to first data store 122 on backup device 104. As mentioned earlier, in examples where additional snapshots (for example, S2, S3, etc.) of a storage volume (for example, 120) are generated, snapshot engine 162 may generate respective backups of some or all of the additional snapshots. In these examples, storage engine 162 may store the respective backups (for example, B4 and B7) of the additional snapshots to first data store 122 on backup device 104.

In an example, map engine 164 may be used to generate an allocation map (for example, S1_alloc) for the first snapshot of storage volume 120. As used herein, an “allocation map” may identify written blocks on a snapshot. For example, an allocation map may identify all non-zero blocks on a snapshot. In an example, an allocation map may include a bit map of the storage volume where each bit may represent a block that has been written to. Storage engine 162 may store the allocation map for the first snapshot in second data store 124 on backup device 104.

In an example, for each additional snapshot that is backed up on the backup device 104 (e.g., B4, B7), map engine 164 may generate a difference map. As used herein, a “difference map” for an additional snapshot may identify changed blocks on the additional snapshot relative to the previous snapshot that was last backed up for storage volume 120. As used herein, a “previous snapshot” in relation to an additional snapshot may refer to a snapshot that was last backed up prior to the additional snapshot (e.g., S4 is a previous snapshot in relation to S7 because S4 was the last backed up snapshot in relation to S7). A difference map may identify changed blocks on a snapshot since the last backup. In an example, a difference map may include a bit map of the volume where the bits may represent blocks that have been changed since the last backup.

In examples where additional snapshots of the storage volume are backed up on backup device 104, map engine 164 may generate a difference map (for example, S1-S4_diff and S4-S7_diff) for each of the additional snapshots that are backed up. In an example, storage engine 162 may store each of the difference maps (for example, S1-S4_diff and S4-S7_diff) in second data store 124 on backup device 104.

Restore engine 166 may be used to restore a backup of a snapshot of storage volume 120 from backup device 104. The backup may include, for example, a backup of the first snapshot or a backup of any of the additional snapshots. In an example, restore engine 166 may receive a request to restore a backup on backup device 104. In an example, the request may be received from a user. In another example, the request may be system-generated. The request may relate to a restoration of the backup of the first snapshot of storage volume 120. In another example, the request may relate to a restoration of the backup of any of the additional snapshots of storage volume 120 that were backed up on backup device 104 (e.g., S4 or S7). Further, the request may relate to a restoration of a backup to storage device 102 or a new storage device (not illustrated). In an example, the request may relate to a restoration of a backup to a new snapshot on storage device 102. In another example, the request may relate to a restoration of a backup to the base volume of storage device 102.

In an example, restore engine 166 may receive a request to restore the backup of the first snapshot of storage volume 120 to a new snapshot on storage device 102. In an example, the request may be received in response to a determination that the first snapshot of storage volume 120 is not available. Restore engine 166 may forward the request to snapshot engine 160. In response to the request, snapshot engine 160 may generate a latest snapshot of storage volume 120. As used herein, a “latest snapshot” may refer to the most recent snapshot. A latest snapshot may include, for example, the first snapshot, an additional snapshot, or the last snapshot. In the context of FIG. 2, S8 may represent the latest snapshot of storage volume 120.

Map engine 164 may generate a difference map for the latest snapshot. The difference map for the latest snapshot may identify changed blocks on the latest snapshot relative to the last snapshot that was backed up on backup device 104. As used herein, a “last snapshot” may refer to a snapshot that was last backed up prior to the latest snapshot. For example, in the context of FIG. 2, a difference map may be generated between snapshots S7 and S8, and represented as S7-S8_diff. Map engine 164 may generate a combined map based on the difference map for the latest snapshot and the respective difference maps of the additional snapshots that were backed up on backup device 104 prior to the latest snapshot. For example, in the context of FIG. 2, a combined map “S1-S8_diff” based on S1-4_diff, S4-7_diff, and S7-8_diff may be generated. Since bit map difference maps of different snapshots of the same volume may be equal in size, logical operations like bitwise OR may be applied to determine a combined map. Restore engine 106 may identify blocks that may have changed between the first snapshot and the latest snapshot from the combined map. For example, in the context of FIG. 2, the combined map “S1-S8_diff” may be used to identify blocks that may have changed between the first snapshot (S1) and the latest snapshot (S8). In an example, the snapshot of the last backup may be maintained until the following backup to allow the next difference map to be created in the chain.

Subsequent to the identification of changed blocks, restore engine 166 may copy the changed blocks from backup device 104 to storage device 102.

In another example, restore engine 166 may receive a request to restore the backup of the first snapshot of storage volume 120 to a new storage device (not illustrated). In response to the request, restore engine 166 may create a storage volume on the new storage device. In an example, the size of the storage volume on the new storage device may correspond to a size of the storage volume 120. Restore engine 166 may then refer to the allocation map for the first snapshot from second data store on backup device 104. Restore engine 166 may determine from the allocation map which blocks are non-zero (or written). Based on the determination, restore engine 166 may copy the non-zero blocks from backup device to the new storage device.

In another example, restore engine 166 may receive a request to restore the backup of an additional snapshot of storage volume 120 to a new storage device. In response to the request, restore engine 166 may read the allocation map for the first snapshot from second data store 124 on backup device 104. Restore engine 166 may also read the difference map for each additional snapshot backed up prior to the backup of the additional snapshot from second data store 124. For example, in the context of FIG. 2, if restore engine 166 receives a request to restore the backup (B4) of the additional snapshot (S4), restore engine 166 may read S1_alloc and S1-S4_diff from second data store. Restore engine 166 may then generate a combined map for the additional snapshot (S4) based on the allocation map for the snapshot, and the difference map for each additional snapshot backed up prior to the backup of the additional snapshot. For example, in the context of FIG. 2, restore engine may generate a combined map S4_alloc=OR (S1_alloc, S1-S4_diff). Since a bit map allocation map of a snapshot and a bit map difference map of snapshots from the same volume may be equal in size, a bitwise OR may be applied to determine a combined map. Based on the combined map, restore engine 166 may determine which blocks are non-zero (or written) from the combined map. Based on the determination, restore engine 166 may copy the non-zero blocks from backup device 104 to the new storage device.

There may be two types of combined map that may be formed. In an example, an allocation map comprised by combining an allocation map and a chain of difference maps to the required backup. This may be useful for identifying blocks that may be non-zero. In another example, a difference map comprised by combining only a subset of chained difference maps. This may be useful for identifying the differing blocks between any volume state that is to be restored over and any backup by combining only the difference maps that link them.

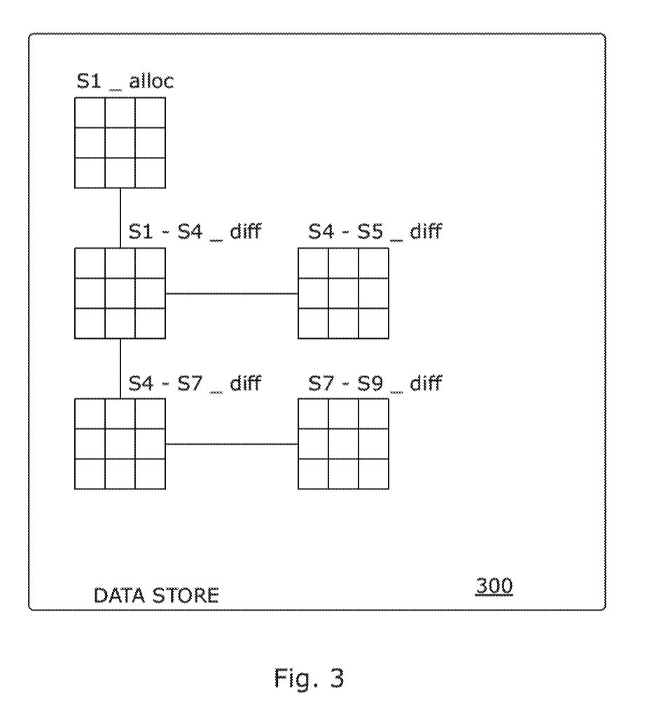

As mentioned earlier, second data store 124 may be a repository that may store an allocation map for the first snapshot of a storage volume (for example, 120), and respective difference maps for any additional snapshots of the storage volume (for example, 120). FIG. 3 illustrates an example second data store 124 representing relationships between snapshots of a storage volume (for example, 120) via allocation and difference maps related thereto. Relationships between snapshots of a storage volume (for example, 120) may be represented in second data store 124, for example, via a graph structure. Some examples of the graph structure may include a tree graph structure and a directed acyclic graph structure. A tree graph may include an undirected graph in which any two vertices are connected by exactly one path. An acyclic graph is a graph without cycles. When the graph is followed from node to node, the same node is never visited twice. A directed acyclic graph is an acyclic graph that has a direction as well as a lack of cycles. In a directed acyclic graph, the nodes are ordered so that the starting node has a lower value than the ending node.

Second data store 124 may also accommodate more complex snapshot relationships without any loss of functionality. For example, allocation maps or difference maps for snapshots of snapshots may be stored and represented in second data store 124. In this context, in an example, snapshot engine 160 may generate a snapshot of the snapshot of a storage volume (for example, 120). Storage engine 162 may store the snapshot of the snapshot in first data store 122. Map engine 164 map generate an allocation map for the snapshot of the snapshot, wherein the allocation map for the snapshot of the snapshot may identify written blocks on the snapshot of the snapshot. Storage engine 162 may store the allocation map for the snapshot of the snapshot in second data store 124. Snapshot engine 160 may generate a backup of the snapshot of the snapshot. Storage engine 162 may store the backup of the snapshot of the snapshot in first data store 122 on backup device 104. Map engine 164 may generate a difference map, wherein the difference map for the snapshot of the snapshot may identify changed blocks on the snapshot of the snapshot relative to the snapshot. In an example, the relationship between the allocation map for the snapshot of the snapshot and the difference map for the snapshot of the snapshot may be represented in the second data store via a graph structure (for example, a tree graph structure and a directed acyclic graph structure).

In an example, other than an allocation map for the first snapshot of a storage volume, additional allocation maps for one or more later snapshots of the storage volume may be generated by snapshot engine 160. The additional allocation maps may be stored in second data store 124 on backup device 104. The additional allocation maps may help shorten the creation of a combined map.

In an example, a backup stored in second data store 124 may be deleted. When a backup is deleted from second data store 124, a chain may be maintained between the snapshots to enable the construction of a combined map and/or a difference map. For example, in the context of FIG. 2, if the latest backup (for example, B7) is deleted then S4-7_diff may be removed from second data store without loss of functionality. If the oldest backup (for example, B1) is deleted then S1_alloc may be deleted when S1-4_diff has been replaced with S4_alloc=OR (S1_alloc, S1-4_diff). If a middle backup (for example, B4) is deleted then S1-4_diff and S4-7_diff may be deleted by replacing them with S1-7_diff=OR (S1-4_diff, S4-7_diff).

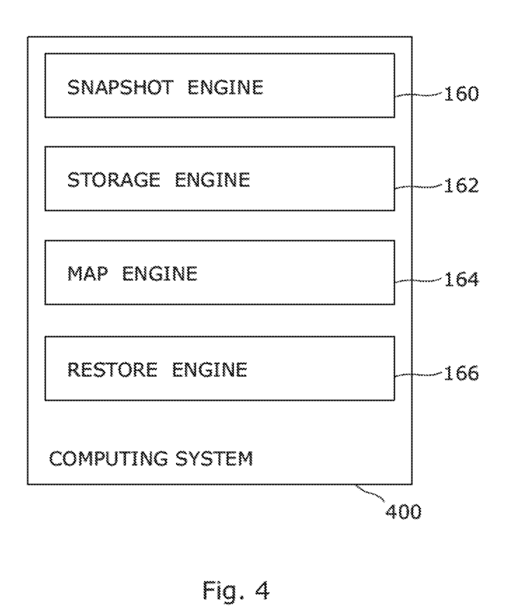

FIG. 4 is a block diagram of an example computing system 400 for restoring a storage volume from a backup. In an example, computing system 400 may be analogous to computing system 106 of FIG. 1, in which like reference numerals correspond to the same or similar, though perhaps not identical, components. For the sake of brevity, components or reference numerals of FIG. 2 having a same or similarly described function in FIG. 1 are not being described in detail in connection with FIG. 2. Said components or reference numerals may be considered alike.

Computing system 400 may be any type of computing device capable of executing machine-readable instructions. Examples of the computing system 400 may include, without limitation, a server, a desktop computer, a notebook computer, a tablet computer, a thin client, a mobile device, a personal digital assistant (PDA), and the like.

In an example, computing system 400 may include a snapshot engine 160, a storage engine 162, a map engine 164, and a restore engine 166.

In an example, snapshot engine 162 may generate a backup of a snapshot of a storage volume (for example, 120) on a storage device (for example, 102). Storage engine 162 may store the backup of the snapshot in a first data store (for example, 122) on a backup device (for example, 104). Map engine 164 may generate an allocation map for the snapshot, wherein the allocation map may identify written blocks on the snapshot. Storage engine 162 may store the allocation map for the snapshot in a second data store (for example, 124) on the backup device. Snapshot engine 160 may generate respective backups of additional snapshots of the storage volume. Storage engine 162 may store the respective backups of additional snapshots in the first data store on the backup device. For each additional snapshot that is backed up on the backup device, map engine 164 may generate a difference map. The difference map for an additional snapshot may identify changed blocks on the additional snapshot relative to a previous snapshot last backed up on the backup device. Storage engine 162 may store each difference map in the second data store on the backup device. In response to a request to restore the backup of the snapshot to a new storage device, restore engine 166 may create a storage volume on the new storage device. Restore engine 166 may read the allocation map for the snapshot from the backup device. Restore engine 166 may identify written blocks on the snapshot from the allocation map, and copy the written blocks from the backup device to the new storage device.

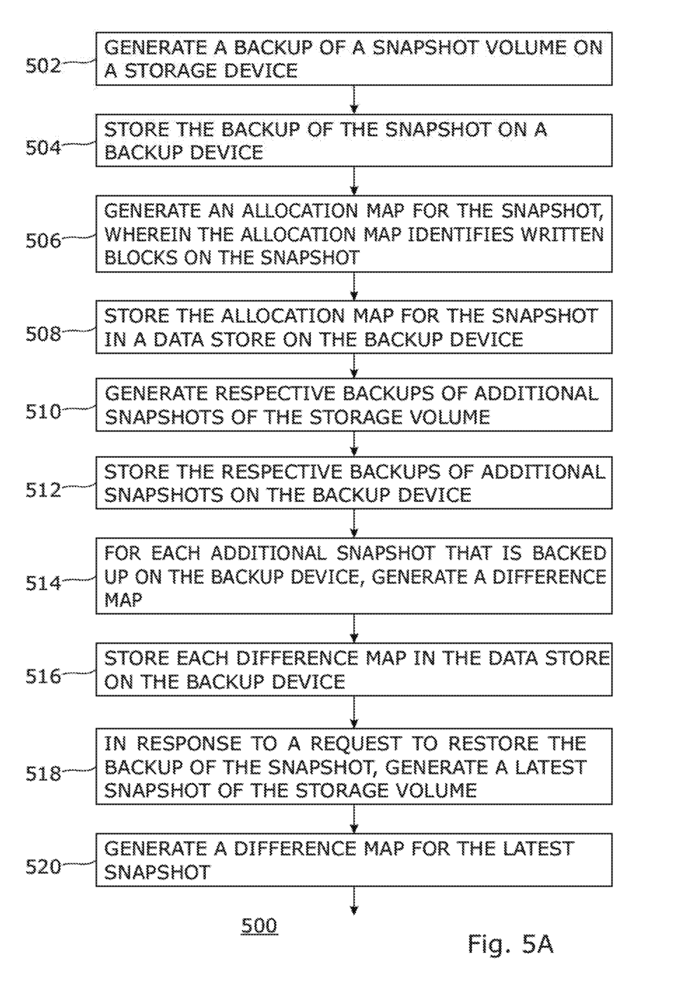

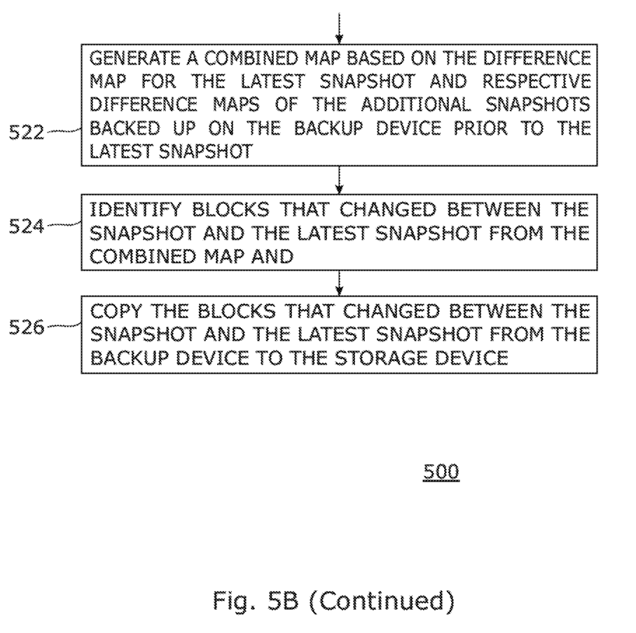

FIGS. 5A-5B illustrate a block diagram of an example method 500 of restoring a storage volume from a backup. The method 500, which is described below, may be partially or fully executed on a computer device such as computing system 106 of FIG. 1, or computing system 400 of FIG. 4. However, other suitable computing devices may execute method 500 as well. At block 502, a backup of a snapshot of a storage volume on a storage device may be generated. At block 504, the backup of the snapshot may be stored on a backup device. At block 506, an allocation map for the snapshot may be generated. The allocation map may identify written blocks on the snapshot. The allocation map for the snapshot may be stored in a data store on the backup device. At block 508, the respective backups of additional snapshots of the storage volume may be generated. At block 510, the respective backups of additional snapshots may be stored on the backup device. At block 512, for each additional snapshot that is backed up on the backup device, a difference map may be generated. The difference map for an additional snapshot may identify changed blocks on the additional snapshot relative to a previous snapshot last backed up on the backup device. At block 514, each difference map may be stored in the data store on the backup device. At block 516, in response to a request to restore the backup of the snapshot, a latest snapshot of the storage volume may be generated. In an example, the request to restore the backup of the snapshot may include a request to restore the backup of the snapshot to a new storage device. At block 518, a difference map for the latest snapshot may be generated. At block 520, the difference map for the latest snapshot may identify changed blocks on the latest snapshot relative to a last snapshot backed up on the backup device. At block 522, a combined map may be generated based on the difference map for the latest snapshot and respective difference maps of the additional snapshots backed up on the backup device prior to the latest snapshot. At block 524, the blocks that changed between the snapshot and the latest snapshot from the combined map may be identified. At block 526, the changed blocks may be copied from the backup device to the storage device.

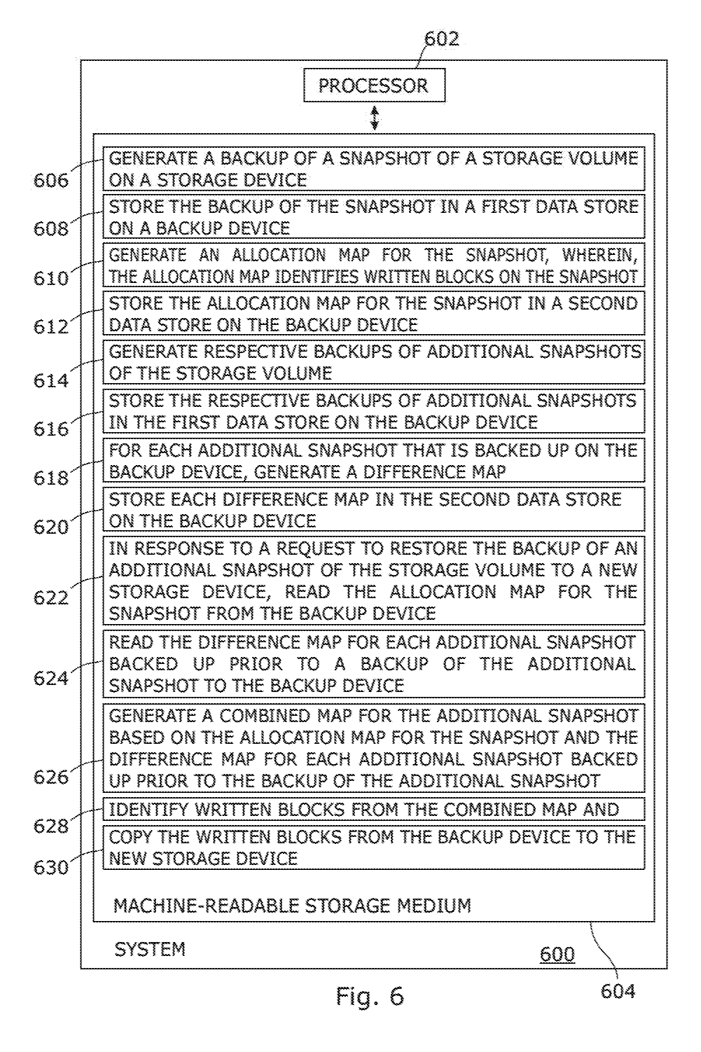

FIG. 6 is a block diagram of an example system 600 for including instructions in a machine-readable storage medium for restoring a storage volume from a backup. System 600 includes a processor 602 and a machine-readable storage medium 604 communicatively coupled through a system bus. In an example, system 600 may be analogous to computing system 106 of FIG. 1, or computing system 400 of FIG. 4. Processor 602 may be any type of Central Processing Unit (CPU), microprocessor, or processing logic that interprets and executes machine-readable instructions stored in machine-readable storage medium 604. Machine-readable storage medium 604 may be a random access memory (RAM) or another type of dynamic storage device that may store information and machine-readable instructions that may be executed by processor 602. For example, machine-readable storage medium 604 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, machine-readable storage medium may be a non-transitory machine-readable medium.

Machine-readable storage medium 604 may store instructions 606, 608, 610, 612, 614, 616, 618, 620, 622, 624, 626, 628, and 630. In an example, instructions 606 may be executed by processor 602 to generate a backup of a snapshot of a storage volume on a storage device. Instructions 608 may be executed by processor 602 to store the backup of the snapshot in a first data store on a backup device. Instructions 610 may be executed by processor 602 to generate an allocation map for the snapshot, wherein the allocation map may identify written blocks on the snapshot. Instructions 612 may be executed by processor 610 to store the allocation map for the snapshot in a second data store on the backup device. Instructions 614 may be executed by processor 610 to generate respective backups of additional snapshots of the storage volume. Instructions 616 may be executed by processor 610 to store the respective backups of additional snapshots in the first data store on the backup device. Instructions 618 may be executed by processor 610 to generate a difference map for each additional snapshot that is backed up on the backup device. The difference map for an additional snapshot may identify changed blocks on the additional snapshot relative to a previous snapshot last backed up on the backup device. Instructions 620 may be executed by processor 610 to store each difference map in the second data store on the backup device. Instructions 622 may be executed by processor 610 to read the allocation map for the snapshot from the backup device, in response to a request to restore the backup of an additional snapshot of the storage volume to a new storage device. In an example, the request may be received in response to a determination that the additional snapshot is not available. Instructions 624 may be executed by processor 610 to read the difference map for each additional snapshot backed up prior to a backup of the additional snapshot to the backup device. Instructions 626 may be executed by processor 610 to generate a combined map for the additional snapshot based on the allocation map for the snapshot and the difference map for each additional snapshot backed up prior to the backup of the additional snapshot. Instructions 628 may be executed by processor 610 to identify written blocks from the combined map. Instructions 630 may be executed by processor 610 to copy the written blocks from the backup device to the new storage device.

For the purpose of simplicity of explanation, the example method of FIG. 5 is shown as executing serially, however it is to be understood and appreciated that the present and other examples are not limited by the illustrated order. The example systems of FIGS. 1, 4, and 6, and method of FIG. 5 may be implemented in the form of a computer program product including computer-executable instructions, such as program code, which may be run on any suitable computing device in conjunction with a suitable operating system (for example, Microsoft Windows, Linux, UNIX, and the like). Examples within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be noted that the above-described examples of the present solution is for the purpose of illustration only. Although the solution has been described in conjunction with a specific example thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

1. A method comprising:
generating a backup of a snapshot of a storage volume on a storage device;
storing the backup of the snapshot on a backup device;
generating an allocation map for the snapshot, wherein the allocation map identifies written blocks on the snapshot;
storing the allocation map for the snapshot in a data store on the backup device;
generating respective backups of additional snapshots of the storage volume;
storing the respective backups of additional snapshots on the backup device;
for each additional snapshot that is backed up on the backup device, generating a difference map, wherein the difference map for an additional snapshot identifies changed blocks on the additional snapshot relative to a previous snapshot last backed up on the backup device;
storing each difference map in the data store on the backup device;
in response to a request to restore the backup of the snapshot, generating a latest snapshot of the storage volume;
generating a difference map for the latest snapshot, wherein the difference map for the latest snapshot identifies changed blocks on the latest snapshot relative to a last snapshot backed up on the backup device;
generating a combined map based on the difference map for the latest snapshot and respective difference maps of the additional snapshots backed up on the backup device prior to the latest snapshot;
identifying blocks that changed between the snapshot and the latest snapshot from the combined map; and
copying the blocks that changed between the snapshot and the latest snapshot from the backup device to the storage device.

2. The method of claim 1, further comprising:
in response to a request to restore the backup of the snapshot to a new storage device, creating a storage volume on the new storage device;
reading the allocation map for the snapshot from the backup device;
identifying written blocks on the snapshot from the allocation map; and
copying the written blocks from the backup device to the new storage device.

3. The method of claim 2, wherein a size of the storage volume on the new storage device corresponds to a size of the storage volume.

4. The method of claim 1, further comprising:
in response to a request to restore the backup of an additional snapshot of the storage volume to a new storage device, reading the allocation map for the snapshot from the backup device;
reading the difference map for each additional snapshot backed up prior to a backup of the additional snapshot to the backup device;
generating a combined map for the additional snapshot based on the allocation map for the snapshot and the difference map for each additional snapshot backed up prior to the backup of the additional snapshot;
identifying written blocks from the combined map; and
copying the written blocks from the backup device to the new storage device.

5. The method of claim 1, wherein the copying includes copying the blocks that changed from the backup device to the latest snapshot of the storage volume on the storage device.

6. The method of claim 1, wherein the copying includes copying the blocks that changed from the backup device to the storage volume on the storage device.

7. The method of claim 1, wherein the request to restore the backup of the snapshot is in response to a determination that the snapshot is not available.

8. The method of claim 1, wherein the request to restore the backup of the snapshot includes a request to restore the backup of the snapshot to the storage device.

9. The method of claim 1, wherein the request to restore the backup of the snapshot includes a request to restore the backup of the snapshot to a new storage device.

10. A system comprising:
a snapshot engine to generate a backup of a snapshot of a storage volume on a storage device;
a storage engine to store the backup of the snapshot in a first data store on a backup device;
a map engine to generate an allocation map for the snapshot, wherein the allocation map identifies written blocks on the snapshot;
the storage engine to store the allocation map for the snapshot in a second data store on the backup device;
the snapshot engine to generate respective backups of additional snapshots of the storage volume;
the storage engine to store the respective backups of additional snapshots in the first data store on the backup device;
the map engine to generate a difference map for each additional snapshot that is backed up on the backup device, wherein the difference map for an additional snapshot identifies changed blocks on the additional snapshot relative to a previous snapshot last backed up on the backup device;
the storage engine to store each difference map in the second data store on the backup device; and
in response to a request to restore the backup of the snapshot to a new storage device, a restore engine to:
create a storage volume on the new storage device;
read the allocation map for the snapshot from the backup device;
identify written blocks on the snapshot from the allocation map; and
copy the written blocks from the backup device to the new storage device.

11. The system of claim 10, wherein the restore engine is to read the allocation map for the snapshot from the second data store on the backup device.

12. The system of claim 10, wherein:
the snapshot engine is to generate a snapshot of the snapshot of the storage volume;
the storage engine is to store the snapshot of the snapshot in the first data store;
the map engine is to generate an allocation map for the snapshot of the snapshot, wherein the allocation map for the snapshot of the snapshot identifies written blocks on the snapshot of the snapshot;
the storage engine is to store the allocation map for the snapshot of the snapshot in the second data store;
the snapshot engine is to generate a backup of the snapshot of the snapshot;
the storage engine is to store the backup of the snapshot of the snapshot in the first data store on the backup device; and
the map engine to generate a difference map, wherein the difference map for the snapshot of the snapshot identifies changed blocks on the snapshot of the snapshot relative to the snapshot.

13. A non-transitory machine-readable storage medium comprising instructions, the instructions executable by a processor to:
generate a backup of a snapshot of a storage volume on a storage device;
store the backup of the snapshot in a first data store on a backup device;
generate an allocation map for the snapshot, wherein the allocation map identifies written blocks on the snapshot;
store the allocation map for the snapshot in a second data store on the backup device;
generate respective backups of additional snapshots of the storage volume;
store the respective backups of additional snapshots in the first data store on the backup device;
generate a difference map for each additional snapshot that is backed up on the backup device, wherein the difference map for an additional snapshot identifies changed blocks on the additional snapshot relative to a previous snapshot last backed up on the backup device;
store each difference map in the second data store on the backup device;
in response to a request to restore the backup of an additional snapshot of the storage volume to a new storage device, read the allocation map for the snapshot from the backup device;
read the difference map for each additional snapshot backed up prior to a backup of the additional snapshot to the backup device;
generate a combined map for the additional snapshot based on the allocation map for the snapshot and the difference map for each additional snapshot backed up prior to the backup of the additional snapshot;
identify written blocks from the combined map; and
copy the written blocks from the backup device to the new storage device.

14. The storage medium of claim 13, further comprising instructions to:
represent relationships amongst the allocation map for the snapshot and respective difference maps for the additional snapshots in the second data store via a graph.

15. The storage medium of claim 14, wherein the graph includes one of a tree graph and a directed acyclic graph.

16. The storage medium of claim 13, wherein instructions to generate the allocation map for the snapshot include instructions to:
generate an additional allocation map for the snapshot, wherein the additional allocation map identifies written blocks on the snapshot; and
store the additional allocation map for the snapshot on the backup device.

17. The storage medium of claim 13, wherein at least one of the allocation map, the difference map, and the combined map is a bit map.

18. The storage medium of claim 13, wherein the request to restore the backup of the additional snapshot is in response to a determination that the additional snapshot is not available.

19. The storage medium of claim 13, further comprising instructions to:
generate a snapshot of the snapshot of the storage volume;
store the snapshot of the snapshot in the first data store;
generate an allocation map for the snapshot of the snapshot, wherein the allocation map for the snapshot of the snapshot identifies written blocks on the snapshot of the snapshot;
store the allocation map for the snapshot of the snapshot in the second data store;
generate a backup of the snapshot of the snapshot;
store the backup of the snapshot of the snapshot in the first data store on the backup device; and
generate a difference map, wherein the difference map for the snapshot of the snapshot identifies changed blocks on the snapshot of the snapshot relative to the snapshot.

20. The storage medium of claim 13, further comprising instructions to:
represent relationship between the allocation map for the snapshot of the snapshot and the difference map for the snapshot of the snapshot in the second data store via a graph.
